(19) United States
(12) Patent Application Publication
(10) Pub. No.: US 2005/0083252 A1
(43) Pub. Date: Apr. 21, 2005

(54) Plasma display panel device using sub-field mode and method of driving the same

(75) Inventors: Chung-wook Roh, Seoul (KR); Young-sun Kim, Suwon-si (KR); Hye-jeong Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/921,956

(22) Filed: Aug. 20, 2004

(30) Foreign Application Priority Data
Aug. 22, 2003 (KR) 03-58245

(51) Int. Cl. G09G 3/28

(52) U.S. Cl. 345/60

(57) ABSTRACT

Provided are a plasma display panel (PDP) device using a sub-field mode and a method of driving the PDP device. The method of driving the PDP includes allocating a first event pulse for generating an even number of light pulses or a second event pulse for generating an odd number of light pulses to each sub-field, and outputting sustain pulses, which generate light pulses, according to the allocated event pulse. Thus, linearity of the gray level can be improved and an image quality can be improved.

### BACKGROUND OF THE INVENTION

This application claims priority from Korean Patent Application No. 2003-58245, filed on Aug. 22, 2003, in the Korean Intellectual Property Office, the disclosure of which is incorporated herein in its entirety by reference.

1. Field of the Invention

The present invention relates to a plasma display panel (PDP) device, and more particularly, to a PDP device using a sub-field mode and a method of driving the PDP device.

2. Description of the Related Art

A plasma display panel (PDP) is a flat panel display device in which light is emitted by injecting mixed gas between two thin glass substrates, thereby applying a voltage therebetween. More specifically, an electric potential difference of pulse shape is formed between an A(address) electrode and a Y sustain electrode and discharged, a discharge of an X sustain electrode into the Y sustain electrode is induced, and phosphors of red (R), green (G), and blue (B) colors are exited by ultraviolet rays generated in the discharging process and combined to display an image.

A pulse-density modulation (PDM) mode and an address display separated (ADS) mode represent a gray level (pixel brightness) in the PDP device, however the latter is generally used since the former has a gray inversion phenomenon.

The ADS method represents 256 gray levels using 8 to 10 sub-fields. Hereinafter, the ADS method is referred to as a sub-field mode.

FIG. 1 illustrates a method of representing a gray level in the sub-field mode.

Referring to FIG. 1, brightness of each pixel is represented by 8 sub-fields (SF1 through SF8), and the brightness of the pixel can be represented by 256 gray levels. The gray level is a numerical value representing the brightness of the pixel. The gray level is also referred to as gray scale since it represents a shade of the pixel. Each of the sub-fields includes a reset period, an address period, and a sustain period. The reset period and the address period respectively have equal sizes in all of the sub-fields, while the sustain period has a different size in each of the sub-fields according to weights of the sub-fields.

FIG. 2 illustrates a method of representing the gray level using the sub-field weight.

Referring to FIG. 2, the sub-fields SF1, SF2, SF3, SF4, SF5, SF6, SF7, and SF8 respectively have sub-field weights of 1, 2, 4, 8, 16, 32, 64, and 128 (that is, 2ⁿ⁻¹, n is the sub-field number). The sum of the sub-field weights is 256, and 256 (0 through 255) gray levels can be represented.

For example, in order to represent gray level 3, the sub-fields SF1 and SF2 are selected, and in order to represent gray level 127, the sub-fields SF1, SF2, SF3, SF4, SF5, SF6, and SF7 are selected. The brightness of the pixel is represented by a sum of sustain pulses included in the selected sub-fields. It is desirable that the required brightness is proportional to the brightness of the pixel represented by a sum of sustain pulses.

FIGS. 3A and 3B are reference views of examples of sustain pulses and light pulses in the conventional sub-field method.

FIG. 3A is a timing diagram for sustain pulses and light pulses in the conventional method. Assuming that the number of sustain pulses of the Y sustain electrode is N, the number of sustain pulses of the X sustain electrode, which are induced by the Y sustain electrode, is N−1.

For example, for the sub-field SF1, the Y sustain electrode has three sustain pulses and the X sustain electrode has two sustain pulses in the sustain periods thereof, and the sum of the sustain pulses, five light pulses, are generated. For the sub-field SF2, the Y sustain electrode has five sustain pulses and the X sustain electrode has four sustain pulses in the sustain periods thereof, and the sum of the sustain pulses, nine light pulses, are generated.

In the conventional sub-field method, a relationship between the gray level, corresponding desired brightness, and an actual brightness is shown in FIG. 3B. That is, it is desirable that the required brightness is proportional to the gray level. For example, referring to FIG. 3B, for the gray levels 1, 2, 3, 4, . . . , the desired brightnesses are 5, 10, 15, 20, . . . , respectively. However, the actual brightnesses are 5, 9, 14, 19, . . . , which are not proportional to the gray scale values. This is because when the number of sustain pulses of the Y sustain electrode is N, the number of sustain pulses of X sustain electrode is N−1, and therefore, the sum of sustain pulses is always 2N−1, that is, an odd number.

That is, according to the conventional sub-field method, since a sustain pulse of an even number cannot be represented, the linearity of the gray level with respect to the image signal cannot be obtained, and the gray scale representation on the screen may not be performed smoothly.

### SUMMARY OF THE INVENTION

The present invention provides a plasma display panel (PDP) device using a sub-field mode and a method of driving the PDP device, by which linearity of a gray level can be ensured.

According to an aspect of the present invention, there is provided a method of driving a plasma display panel (PDP) device using a sub-field mode including (a) allocating a first event pulse for generating an even number of light pulses or a second event pulse for generating an odd number of light pulses to each sub-field, and (b) outputting sustain pulses, which generate light pulses, according to the allocated event pulse.

Step (a) may include selecting one of the first event pulse or the second event pulse so that a linearity between a gray level and the light pulses to be generated can be ensured, and more particularly, may include selecting one of the first event pulse or the second event pulse so that actual brightnesses represented by the gray level of the sub-fields are equal to those required logically.

Step (b) may include (b1) if the first event pulse is allocated to a sub-field, outputting sustain pulses of an X electrode and a Y electrode for generating an even number of light pulses; and (b2) if the second event pulse is allocated to a sub-field, outputting sustain pulses of the X electrode and the Y electrode for generating an odd number of light pulses.

The first event pulse may be a driving waveform, in which a sustain period starts with a first sustain pulse, which is wide, of a Y electrode, continues with alternate sustain pulses of the X electrode and a Y electrode, and a last sustain pulse, which is narrow, of X electrode is terminated by an erase pulse of the X electrode.

The second event pulse may be a driving waveform, in which a sustain period starts with a first sustain pulse, which is wide, of the Y electrode, continues with alternate sustain pulses of the X electrode and the Y electrode, with the last sustain pulse being generated by the Y electrode, and is terminated by an erase pulse of the X electrode.

According to another aspect of the present invention, there is provided a plasma display panel (PDP) using a sub-field mode including an event pulse allocating unit that allocates a first event pulse for generating an even number of light pulses or a second event pulse for generating an odd number of light pulses to each sub-field; a first event pulse generator that outputs sustain pulses for generating an even number of light pulses according to the allocated event pulse, and a second event pulse generator that outputs sustain pulses for generating an odd number of light pulses according to the allocated event pulse.

The event pulse allocating unit may select one of the first event pulse or the second event pulse so that a linearity between a gray level and the light pulses to be generated can be ensured, and more specifically, may select one of the first event pulse or the second event pulse so that the actual brightnesses represented by the gray level of the sub-fields are equal to those required logically.

The first event pulse generator may output X sustain pulses and Y sustain pulses for generating an even number of light pulses according to the first event pulse allocated to the sub-field.

The second event pulse generator may output X sustain pulses and Y sustain pulses for generating an odd number of light pulses according to the second event pulse allocated to the sub-field.

The PDP device may be a digital television, a personal digital assistant (PDA), a web pad, or a cellular phone.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a method of representing a gray level in a sub-field method;

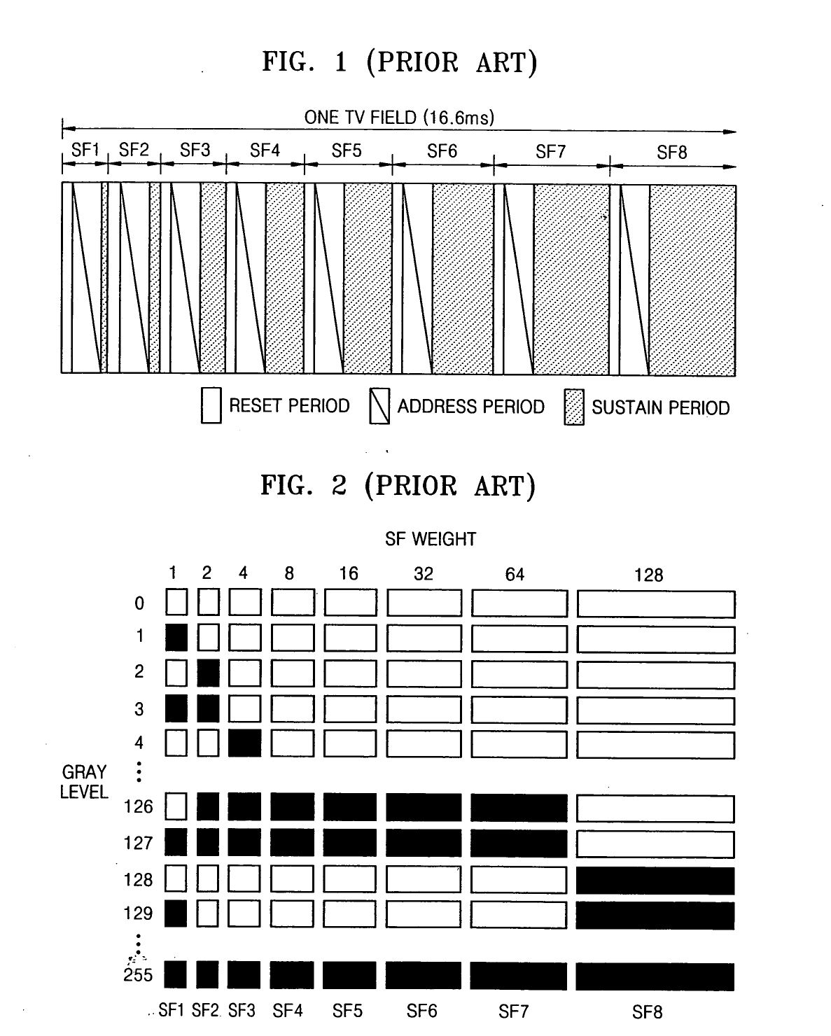

FIG. 2 illustrates a method of representing a gray level using a sub-field weight;

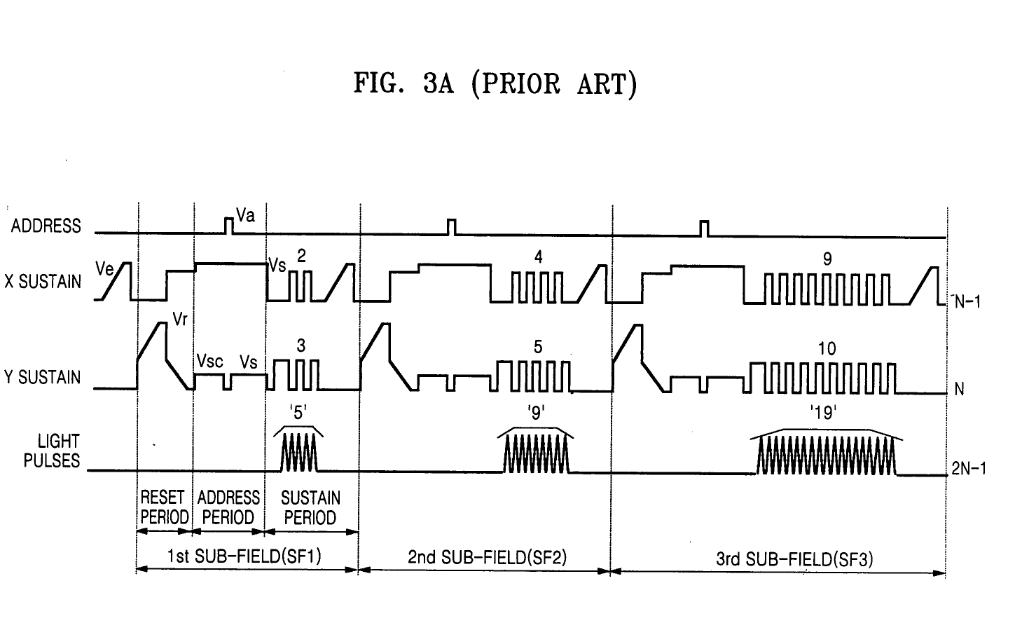

FIG. 3A is a timing diagram for sustain pulses and light pulses in the conventional sub-field method;

FIG. 3B is a table illustrating actual brightness and required brightness for given gray levels in the conventional sub-field method;

FIG. 4 is a block diagram of a plasma display panel (PDP) device according to an exemplary embodiment of the present invention;

FIG. 5 is a block diagram of a driving waveform generator of the PDP device according to the present invention;

FIGS. 6A and 6B are timing diagrams of a first event pulse and a second event pulse according to the present invention;

FIGS. 7A and 7B illustrate examples of sustain pulses and light pulses generated using the event pulse of the present invention; and

FIGS. 8A, 8B, and 8C are views of experimental results that improve linearity of gray levels according to the present invention.

### DETAILED DESCRIPTION OF THE INVENTION

Hereinafter, an exemplary embodiment of the present invention will be described in detail with reference to the accompanying drawings.

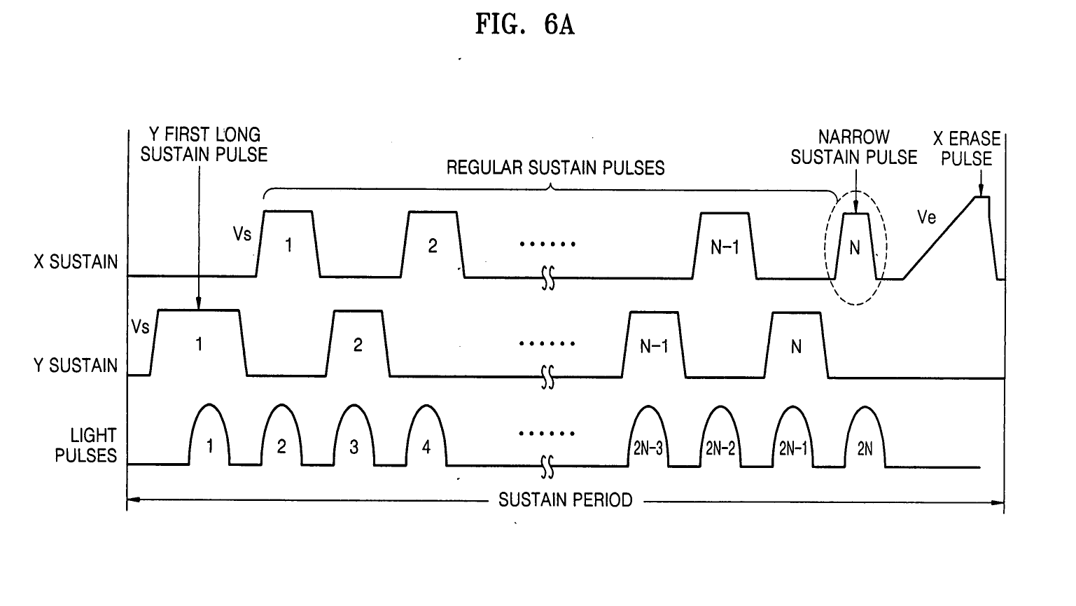

FIG. 4 is a block diagram of a plasma display panel (PDP) device 1 according to an exemplary embodiment of the present invention.

Referring to FIG. 4, the PDP device 1 includes a gray level controller 401, a sub-field processor 402, a driving waveform generator 403, a data driving unit 404, a sustain electrode driving unit 405, and a PDP 406.

The gray level controller 401 receives an image signal, sets an appropriate gray level that represents brightness of a pixel in response to the received image signal, selects appropriate sub-fields for implementing the set gray level, and transmits information regarding the sub-field selection to the sub-field processor 402.

The sub-field processor 402 receives the information regarding the sub-field selection from the gray level controller 401 and generates a conversion timing signal, and transmits the conversion timing signal to the driving waveform generator 403 and the data driving unit 404.

The driving waveform generator 403 generates a voltage driving waveform, which will be input to sustain electrodes (X electrode and Y electrode) during a sustain period, according to the received conversion timing signal, and transmits the generated driving waveform to the sustain electrode driving unit 405.

The data driving unit 404 applies a data voltage, which indicates a positional address of the pixel of the PDP, to an address electrode (A electrode) in an address period according to the conversion timing signal received from the sub-field processor 402.

The sustain electrode driving unit 405 applies voltages to the sustain electrodes (X electrode and Y electrode) according to the driving waveform received from the driving waveform generator 403.

The PDP 406 includes the address electrode, X sustain electrode, and Y sustain electrodes (not shown). The sustain driving waveform is applied to the X electrode and the Y electrode from the sustain electrode driving unit 405, and an address pulse is applied to the A electrode from the data driving unit 404. As described above, voltages according to the driving waveforms and address are applied to the X electrode, Y electrode, and A electrode to display the brightness of pixels in the displayed image.

The PDP device 1 may be a digital TV, a personal digital assistance (PDA), a web pad, or a cellular phone.

The driving waveform generator 403 in the PDP device 1 of the present invention will now be described in more detail.

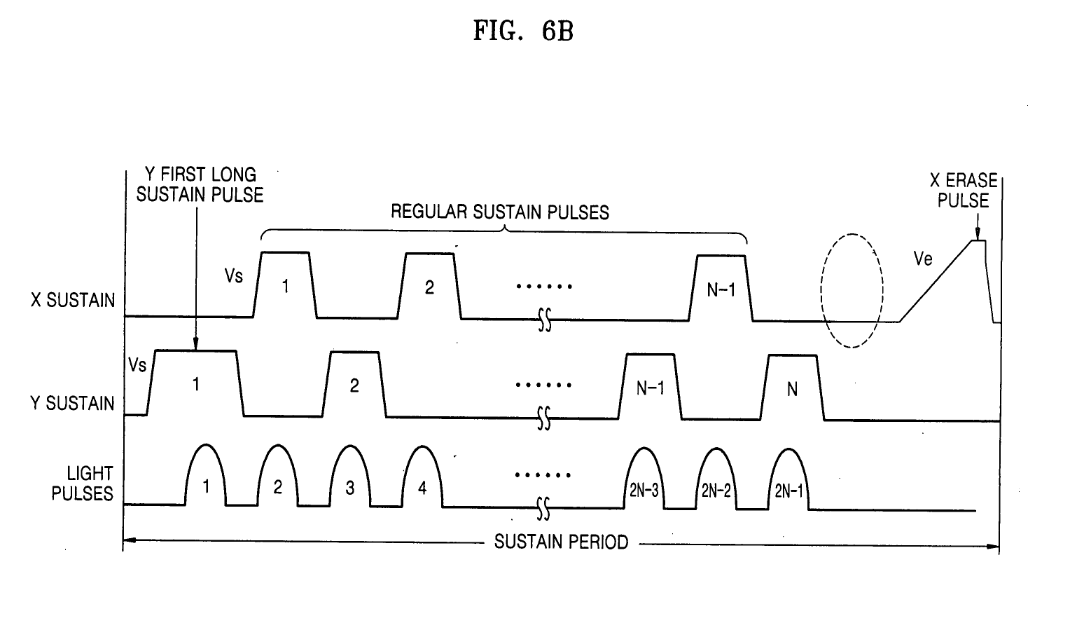

FIG. 5 is a block diagram of the driving waveform generator 403.

Referring to FIG. 5, the driving waveform generator 403 includes a first event pulse generator 501, a second event pulse generator 502, and an event pulse allocating unit 503.

The event pulse allocating unit 503 allocates the first event pulses for generating an even number of light pulses and the second event pulses for generating an odd number of light pulses to the sub-fields. That is, the event pulse allocating unit 503 receives the conversion timing signal from the sub-field processor 402, and selects one of the first event pulse and the second event pulse so that the linearity of the gray level is ensured of each sub-field. The first or second event pulse is selected so that the actual brightness represented by the gray level is the same as logically required. The method of selecting the event pulse will now be described.

The first event pulse generator 501 outputs a sustain pulse for generating the even number of light pulses according to the allocated event pulse. That is, the first event pulse generator 501 outputs X sustain pulses and Y sustain pulses, which generate the even number of light pulses according to the first event pulses allocated to the sub-fields.

The second event pulse generator 502 outputs a sustain pulse for generating the odd number of light pulses according to the allocated event pulse. That is, the second event pulse generator 502 outputs X sustain pulses and Y sustain pulses, which generate the odd number of light pulses, according to the second event pulses allocated to the sub-fields.

A method of driving the PDP device will now be described. Specifically, the structures of the first event pulse, the second event pulse, and the sustain pulse driven actually will be described in detail.

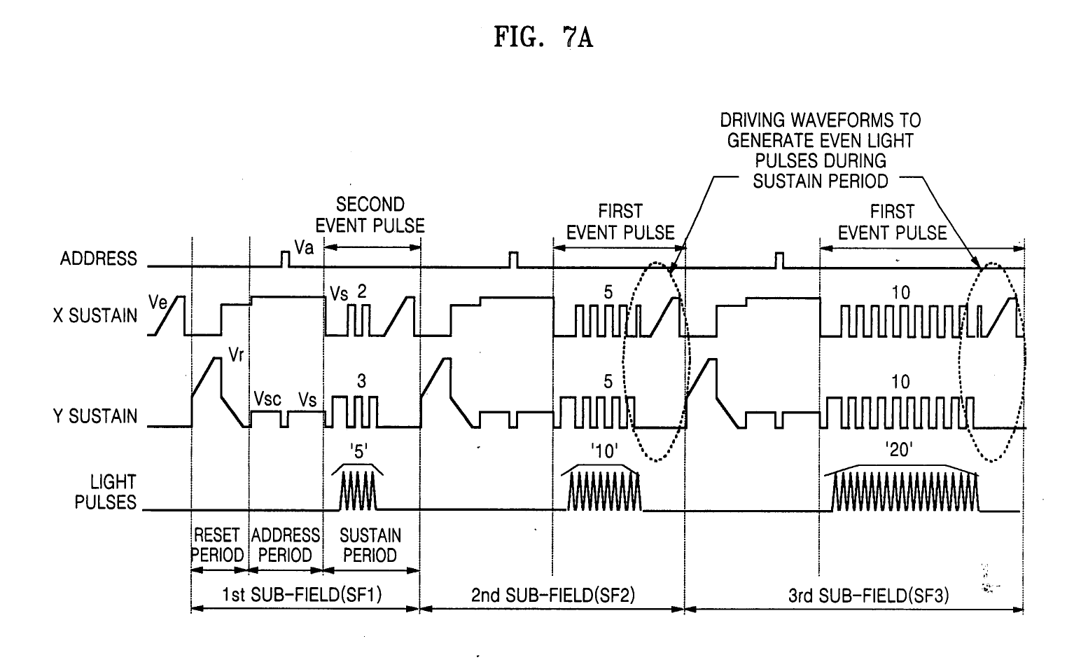

FIGS. 6A and 6B are timing diagrams of the first event pulse and the second event pulse generated by the event pulse allocating unit 503.

FIG. 6A illustrates the first event pulse for generating the even number of light pulses.

The first event pulse is a driving waveform, in which the sustain period starts with a wide sustain pulse Vs1 of Y electrode, continues with alternate sustain pulses of X electrode and Y electrode (Vs1 through Vs N−1 of X electrode and Vs2 through VsN of Y electrode), a narrow sustain pulse VsN of X electrode having a smaller width than that of a normal sustain pulse after the last normal sustain pulse Vs N−1 of X electrode, and an erase pulse of the X electrode is generated to terminate the sustain period.

The dotted line represents that the sustain pulse VsN of the X electrode having the smaller width than the width of each of the normal sustain pulses is generated after the last normal sustain pulse Vs N−1 of the X electrode.

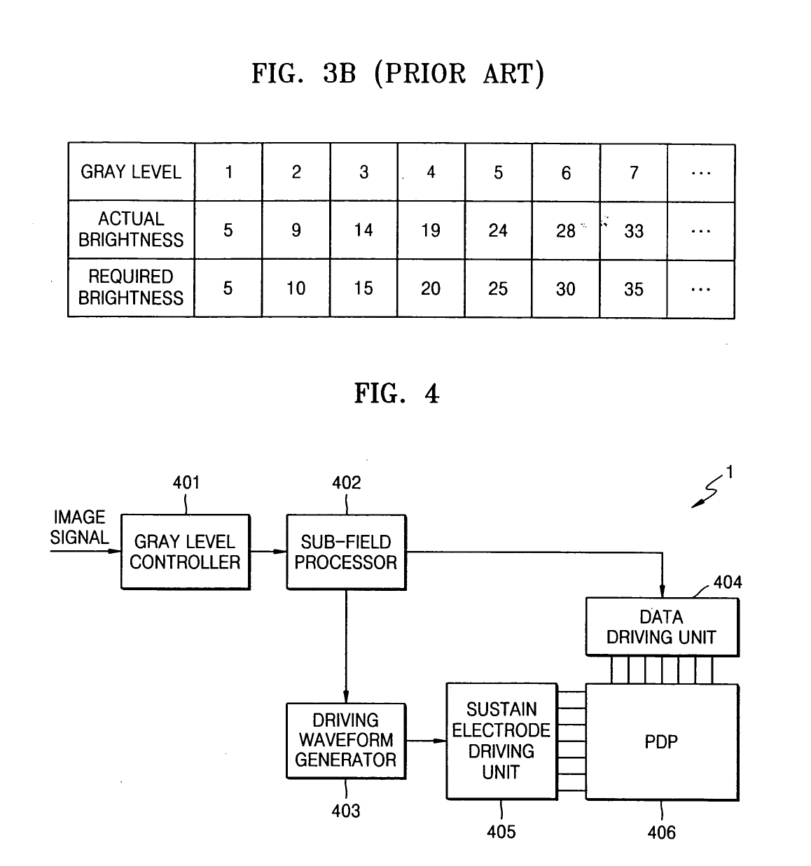

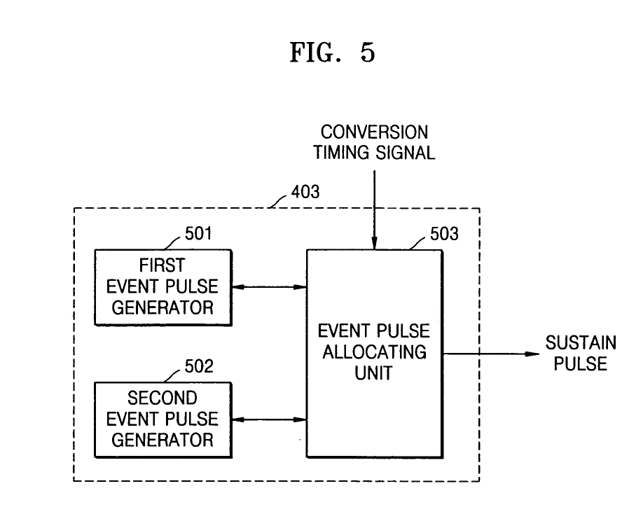

In the conventional PDP device, referring to FIGS. 3A and 3B, the number of sustain pulses is always odd since the sum of sustain pulses is 2N−1 (N−1 sustain pulses of X electrode plus N sustain pulses of the Y electrode). However, according to an exemplary embodiment of the present invention, the sustain pulse Vs N having the smaller width than the width of each of the normal sustain pulses is generated after the last normal sustain pulse VsN of the X electrode, thus the number of sustain pulses generated is 2N, that is, an even number. Accordingly, 2N light pulses representing the brightness of the pixels are generated.

The second event pulse is illustrated in FIG. 6B.

In the second event pulse, the sustain period starts with the wide sustain pulse Vs 1 of the Y electrode, continues with alternate sustain pulses of X electrode and Y electrode (Vs 1 through Vs N−1 of X electrode and Vs2 through Vs N of Y electrode), and is terminated with the erase pulse of the X electrode. Since N−1 sustain pulses of X electrode and N sustain pulses of Y electrode are generated, 2N−1 sustain pulses, that is, an odd number of sustain pulses are generated and thus, 2N−1 light pulses are generated.

A method of allocating the event pulse will now be described in more detail.

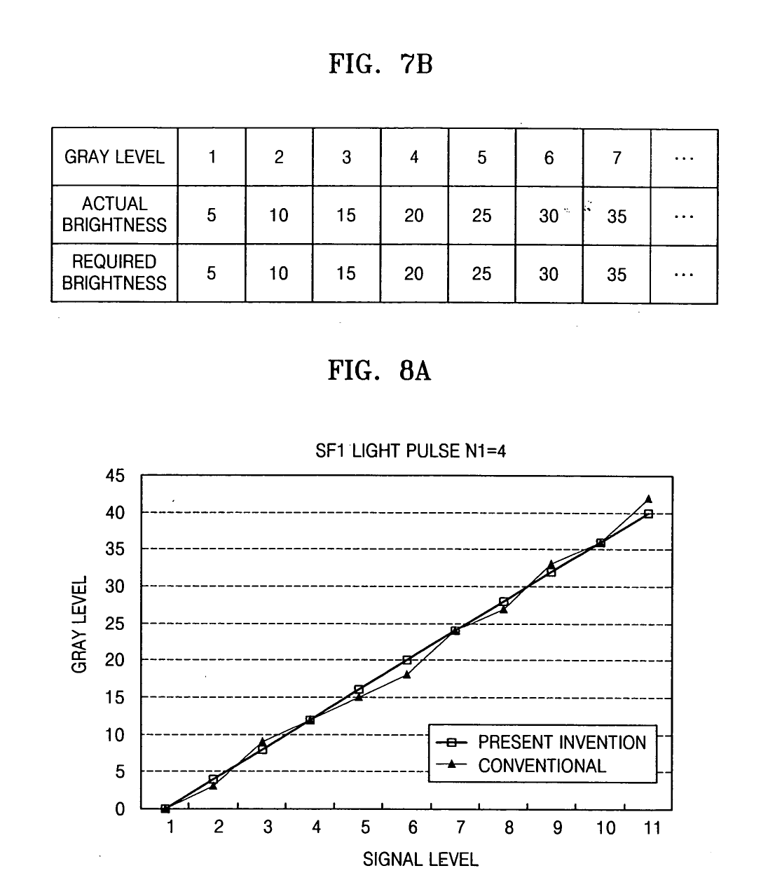

FIGS. 7A and 7B are views of examples of sustain pulse and light pulse using the event pulse according to the present invention.

Referring to FIG. 7A, the sub-field SF1 represents gray level 1, the sub-field SF2 represents the gray level 2, and the sub-field SF3 represents the gray level 4.

Referring to FIG. 7B, required brightnesses for the gray level 1 (SF1), gray level 2 (SF2), and gray level 4 (SF3) are 5, 10, and 20 respectively. Therefore, for the sub-field SF1 corresponding to the gray level 1, since the required brightness is 5, which is an odd number, the second event pulse which generates an odd number of light pulses, is allocated thereto.

On the other hand, for the sub-field SF2 corresponding to the gray level 2, since the required brightness is 10, which is an even number, the first event pulse which generates an even number of light pulses, is allocated thereto. Also, for the sub-field SF3 corresponding to the gray level 4, since the required brightness is 20, which is an even number, the first event pulse which generates an even number of light pulses, is allocated thereto.

In other words, one of the first event pulse and the second event pulse selected appropriately so that the linearity between the gray level and the actual brightness can be maintained. That is, the event pulse is selected so that the actual brightness and the required brightness are equal.

FIG. 7A illustrates the driving waveforms according to the allocated event pulses.

Referring to FIG. 7A, since the second event pulse is allocated to the sub-field SF1, 5 sustain pulses and 5 light pulses are obtained. In addition, since the first event pulse is allocated to the sub-fields SF2 and SF3, 10 and 20 sustain pulses and light pulses are obtained respectively. Therefore, as shown in FIG. 7B, the actual brightness is represented as 5, 10, 15, 20, . . . for the gray levels 1, 2, 3, 4, . . . , respectively. Thus, the linearity between the gray level and the actual brightness is obtained.

However, referring to FIG. 3B, in the conventional PDP device, the actual brightness for the gray levels 1, 2, 3, 4, . . . is 5, 9, 14, 19, . . . , respectively. Thus, the linearity between the gray level and the actual brightness cannot be ensured.

However, according to the present exemplary embodiment of the present invention, since linearity can be ensured for the brightness and the gray level, the brightness of the pixels can be smoothly represented and the image quality can be improved.

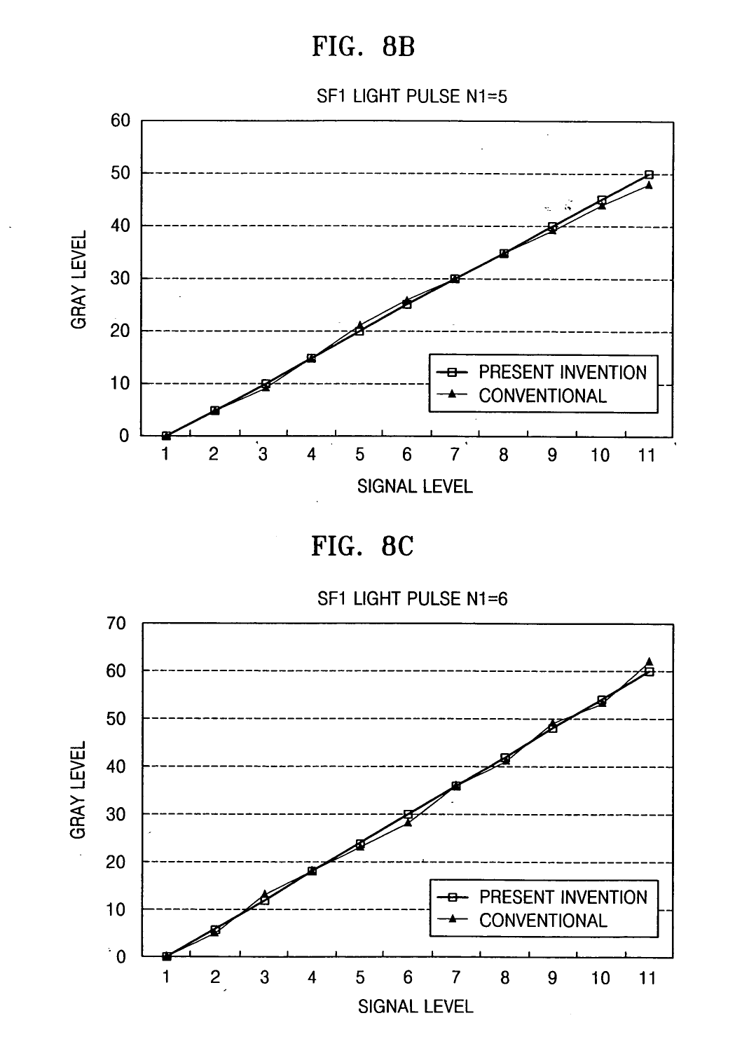

FIGS. 8A, 8B, and 8C are graphs illustrating the relationship between the gray level and the signal level according to the exemplary embodiment of the present invention.

Referring to FIGS. 8A, 8B, and 8C, various digital images were used to obtain the results. According to the results, the linearity of the gray level of the present invention (present invention) is improved over the conventional PDP device (conventional).

A method of driving the PDP device in the sub-field method according to an exemplary embodiment of the present invention will now be described.

The first event pulse for generating an even number of light pulses and the second event pulse for generating an odd number of light pulses are allocated to the sub-fields.

That is, one of the first event pulse and the second event pulse is selected to ensure that the brightness is proportional to the gray level with respect to the sub-field for representing the gray level. In order to select the appropriate event pulse, one of the first event pulse and the second event pulse is selected so that the actual brightness represented by the gray level is the same as the logically required brightness.

The sustain pulses for generating the light pulses are output according to the event pulse allocated to the sub-field.

That is, when the first event pulse is allocated, the sustain pulses of X electrode and Y electrode for generating the even number of light pulses are output. When the second event pulse is allocated, the sustain pulses of X electrode and Y electrode for generating the odd number of light pulses are output. Here, the first event pulse and the second event pulse for generating even or odd number of light pulses are as described above.

Accordingly, the first or second event pulse that generates an even or odd number of light pulses is appropriately allocated to the sub-field according to the brightness required by the sub-field, and the sustain pulses of the X electrode or the Y electrode are generated according to the event pulse, thus making the actual brightness equal to the required brightness and ensuring the linearity of the pixel brightness (gray level).

As described above, according to the exemplary embodiments of the present invention, since an even number of the sustain pulses can be output, the event pulse can generate an even or odd number of light pulses to be allocated to each of the sub-fields according to the gray level, and thus, the brightness can be proportional to the gray level. Therefore, the brightness(gray level) of each of the pixels is smoothly represented and the image quality is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of driving a plasma display panel (PDP) device using a sub-field mode, the method comprising:
(a) allocating a first event pulse for generating an even number of light pulses or a second event pulse for generating an odd number of light pulses to each sub-field; and
(b) outputting sustain pulses for generating the light pulses according to the allocated first or second event pulse.

2. The method of claim 1, wherein step (a) comprises:
selecting one of the first event pulse or the second event pulse so that a linearity between a gray level and the light pulses to be generated can be ensured.

3. The method of claim 1, wherein step (a) comprises:
selecting one of the first event pulse or the second event pulse so that actual brightnesses represented by the gray level of the sub-fields are equal to those of required logically.

4. The method of claim 1, wherein step (b) comprises:
(b1) if the first event pulse is allocated to a sub-field, outputting sustain pulses of an X electrode and a Y electrode for generating an even number of light pulses; and
(b2) if the second event pulse is allocated to a sub-field, outputting sustain pulses of the X electrode and the Y electrode for generating an odd number of light pulses.

5. The method of claim 1, wherein the first event pulse is a driving waveform, in which a sustain period starts with a first sustain pulse, which is wide, of a Y electrode, continues with alternate sustain pulses of the X electrode and a Y electrode, and a last sustain pulse, which is narrow, of X electrode is terminated by an erase pulse of the X electrode.

6. The method of claim 1, wherein the second event pulse is a driving waveform, in which a sustain period starts with a first sustain pulse, which is wide, of the Y electrode, continues with alternate sustain pulses of the X electrode and the Y electrode, with the last sustain pulse being generated by the Y electrode, and is terminated by an erase pulse of the X electrode.

7. A plasma display panel (PDP) device using a sub-field mode comprising:
an event pulse allocating unit that allocates a first event pulse for generating an even number of light pulses or a second event pulse for generating an odd number of light pulses to each sub-field;
a first event pulse generator that outputs sustain pulses for generating an even number of the light pulses according to the allocated event pulse; and
a second event pulse generator that outputs sustain pulses for generating an odd number of the light pulses according to the allocated event pulse.

8. The PDP device of claim 7, wherein the event pulse allocating unit selects one of the first event pulse or the second event pulse so that a linearity between a gray level and the light pulses to be generated can be ensured.

9. The PDP device of claim 7, wherein the event pulse allocating unit selects one of the first event pulse or the second event pulse so that the actual brightnesses represented by the gray level of the sub-fields are equal to those of required logically.

10. The PDP device of claim 7, wherein the first event pulse generator outputs X sustain pulses and Y sustain pulses for generating an even number of light pulses according to the first event pulse allocated to the sub-field.

11. The PDP device of claim 7, wherein the second event pulse generator outputs X sustain pulses and Y sustain pulses for generating an odd number of light pulses according to the second event pulse allocated to the sub-field.

12. The PDP device of claim 7, wherein the first event pulse is a driving waveform, in which a sustain period starts with a first sustain pulse, which is wide, of the Y electrode, continues with alternate sustain pulses of the X electrode and the Y electrode and a last sustain pulse, which is narrow, of X electrode and is terminated by an erase pulse of the X electrode.

13. The PDP device of claim 7, wherein the second event pulse is a driving waveform, in which a first sustain period starts with a sustain pulse, which is wide, of the Y electrode, continues with alternate sustain pulses of the X electrode and the Y electrode, with the last sustain pulse being generated by the Y electrode, and is terminated by an erase pulse of the X electrode.

14. The PDP device of claim 7, being a digital television, a personal digital assistant (PDA), a web pad, or a cellular phone.
